(19) United States
(12) Patent Application Publication
(10) Pub. No.: US 2026/0160636 A1
(43) Pub. Date: Jun. 11, 2026

(54) MOISTURE AND WATER INGRESS DETECTION ASSEMBLY

(71) Applicant: HL MANDO CORPORATION, Gyeonggi-do (KR)

(72) Inventors: Douglas WIRSING, Auburn, MI (US); Lucas RITTER, Auburn, MI (US); Shakil HOSSAIN, Auburn, MI (US)

(21) Appl. No.: 19/319,991

(22) Filed: Sep. 5, 2025

Related U.S. Application Data
(60) Provisional application No. 63/729,875, filed on Dec. 9, 2024.

(51) Int. Cl. G01M 3/40

(52) U.S. Cl. CPC G01M 3/40

(57) ABSTRACT

A moisture detection assembly includes a moisture detection circuit disposed on a printed circuit board, and the moisture detection circuit includes at least two probes that are disposed side-by-side to one another on the printed circuit board. The moisture detection circuit is coupled to a controller configured to obtain moisture readings from the moisture detection circuit by determining a change in capacitance and a change in resistance between the at least two probes.

### CROSS REFERENCE TO PARENT APPLICATIONS

This application claims the benefit of U.S. patent application Ser. No. 63/729,875 filed on Dec. 9, 2024, entitled “Electronic Circuit to Detect and Measure Water and Humidity Ingress in Electronic Modules-Directly and Remotely Sensed”, the entirety of which is incorporated herein by reference.

### BACKGROUND

Various embodiments of the present disclosure relate in general to assemblies (e.g., systems, apparatuses, and/or devices) for detecting water ingress (i.e., unwanted intrusion of moisture, humidity, and/or water into a structure or space where such moisture, humidity, and/or water should not be present).

Water and electronics do not mix well. In particular, there are concerns of system failure due to water ingress into portions of a system, assembly, and/or environment where electronics (e.g., electronic circuitry or the like) reside. For example, water splashing on a circuit board (e.g., a printed circuit board (PCB), or the like) could cause the entire system connected to the circuit board to fail. Humidity and/or moisture being present within such systems, assemblies, and/or environments where electronics reside could also cause similar failures.

It is with respect to these and other general considerations that the following embodiments have been described. Also, although relatively specific problems have been discussed, it should be understood that the embodiments should not be limited to solving the specific problems identified in the background.

### SUMMARY

The features and advantages of the present disclosure will be more readily understood and apparent from the following detailed description, which should be read in conjunction with the accompanying drawings, and from the claims which are appended to the end of the detailed description.

According to various embodiment of the present disclosure, a moisture detection assembly may comprise: a moisture detection circuit disposed on a printed circuit board, the moisture detection circuit comprising at least two probes that are disposed side-by-side to one another on the printed circuit board. Wherein the moisture detection circuit is coupled to a controller configured to obtain moisture readings from the moisture detection circuit by determining a change in capacitance and a change in resistance between the at least two probes.

The controller is configured to detect moisture based on the change in the capacitance between the at least two probes and to identify a type of water associated with the moisture that is detected based on the change in the resistance between the at least two probes.

The type of the water that is detected comprises distilled water, bottled water, rainwater, tap water, and salt water.

The moisture detection circuit comprises at least one capacitor, and a value of the at least one capacitor being equal to a capacitance value between the at least two probes that is associated with a no moisture detected condition.

The controller is configured to provide a time varying signal as an input signal into the moisture detection circuit and receives an output signal based on the time varying signal from the moisture detection circuit, the time varying signal being changed based on the change in the capacitance and the change in the resistance between the at least two probes.

The controller is configured to obtain a contaminant concentration level of the type of the water that is detected based on the change in the resistance between the at least two probes, and a magnitude of the change in the resistance.

The at least two probes comprise a first terminal pad as a first probe of the at least two probes and a second terminal pad as a second probe of the at least two probes, and the first terminal pad and the second terminal pad both comprise copper pads and are disposed on an external surface of the printed circuit board.

The at least two probes comprise a first copper trace as a first probe of the at least two probes and a second copper trace as a second probe of the at least two probes, and the first copper trace and the second copper trace are disposed parallel to one another on an external surface of the printed circuit board.

The printed circuit board is enclosed in a watertight enclosure, and the moisture detection assembly is configured to detect water leakage into the watertight enclosure.

The watertight enclosure is disposed in a tilted manner within a system in which the moisture detection assembly is installed.

According to various embodiment of the present disclosure, a moisture detection assembly may comprise: a moisture detection circuit comprising: a first portion that is disposed on a first printed circuit board, and the first printed circuit board comprising a controller; and a second portion that is disposed on a second printed circuit board that is remote to the first printed circuit board, the second portion comprising at least two probes that are disposed side-by-side to one another on the second printed circuit board and that are remotely connected to the first portion of the moisture detection circuit. Wherein the controller on the first printed circuit board is configured to obtain moisture readings from the at least two probes on the second printed circuit board by determining a change in capacitance and a change in resistance between the at least two probes that are on the second printed circuit board.

The at least two probes of the second portion of the moisture detection circuit are connected to the first portion of the moisture detection circuit via signal communication paths.

The controller is configured to detect moisture based on the change in the capacitance between the at least two probes and to detect a type of water associated with the moisture that is detected based on the change in the resistance between the at least two probes.

The type of the water that is detected comprises distilled water, bottled water, rainwater, tap water, and salt water.

The controller is configured to obtain a contaminant concentration level of the type of the water that is detected based on the change in the resistance between the at least two probes, and a magnitude of the change in the resistance is dependent on an amount of space that exists between the at least two probes.

The controller is configured to provide a time varying signal as an input signal into the moisture detection circuit and receives an output signal based on the time varying signal from the moisture detection circuit, the time varying signal being changed based on the change in the capacitance and the change in the resistance between the at least two probes.

The controller is configured to provide the time varying signal to the at least two probes via the signal communication paths, the first portion of the moisture detection circuit is configured to receive a return signal from the at least two probes via the signal communication paths, the first portion of the moisture detection circuit is configured to process the return signal to generate the output signal that is provided to the controller.

The first printed circuit board is enclosed within a first watertight enclosure and the second printed circuit board is enclosed within a second watertight enclosure that is separate and physically spaced apart from the second watertight enclosure, and the signal communication paths comprise communication wires that run between the first watertight enclosure and the second watertight enclosure.

The second watertight enclosure is disposed in a tilted manner within a system is which the moisture detection assembly is installed.

The first printed circuit board is enclosed within a first watertight enclosure and the second printed circuit board is enclosed within a second watertight enclosure that is separate and physically spaced apart from the second watertight enclosure, and the signal communication paths are non-physical signals that are transmitted between the first watertight enclosure and the second watertight enclosure.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIGS. 1A-1C show a moisture detection assembly according to an exemplary embodiment of the present disclosure.

FIGS. 2A-2B show another moisture detection assembly according to an exemplary embodiment of the present disclosure.

FIG. 3 shows a table according to an exemplary embodiment of the present disclosure.

FIG. 4 shows a schematic view of a vehicle including a steering system, a brake assembly, and the moisture detection assembly of FIGS. 1A-2B according to an exemplary embodiment of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

References to an “operable connection” or “operably connected” means that a particular device is able to communicate (e.g., send and receive data or the like) with one or more other devices. The devices themselves may be directly connected to one another or may be indirectly connected to one another through any number of intermediary devices, such as in a network topology. The connections between the devices may be wired and/or wireless connections.

In the context of embodiments disclosed herein, the term “water ingress” is defined as the unwanted intrusion of moisture, humidity, and/or water into a structure or space where such moisture, humidity, and/or water should not be present. More specifically, the term “water ingress” should not be limited to only the intrusion of water, but also to the intrusion of moisture, humidity, and/or any other types or forms of water and/or of a presence of water. Additionally, the terms “water”, “humidity”, and “moisture” is used interchangeably within this disclosure. For example, a “moisture detection assembly” should also be interpreted to cover a “water detection assembly”, and (in general) any type of assembly that could be used to detect any type or form of “water”, “humidity”, and/or “moisture” (and other similar and/or related terms).

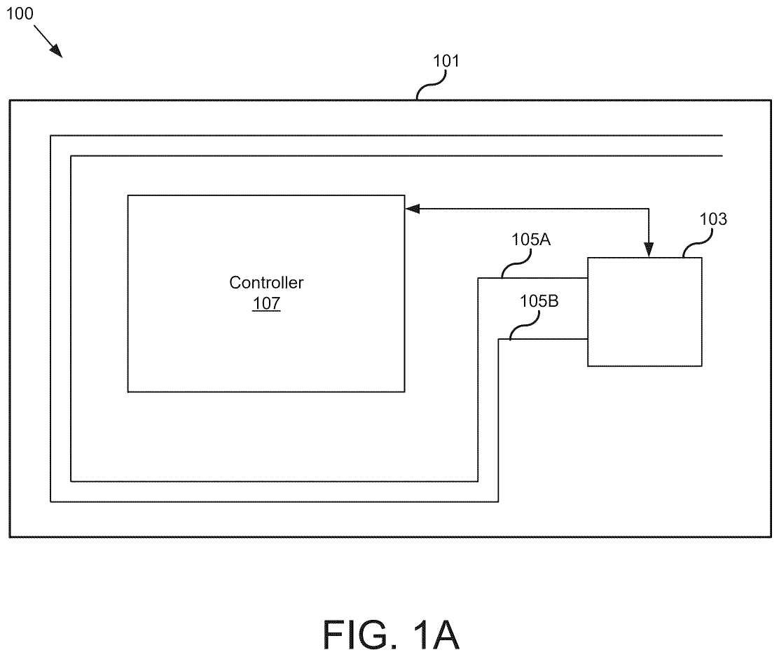

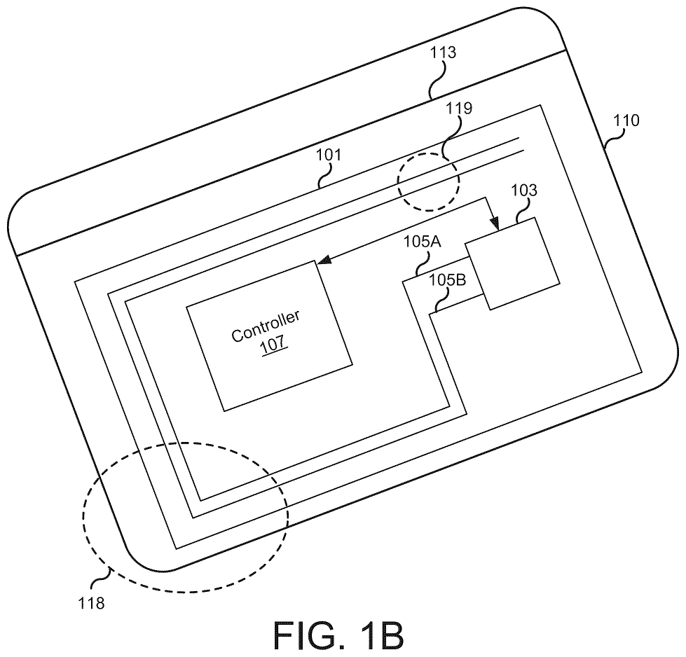

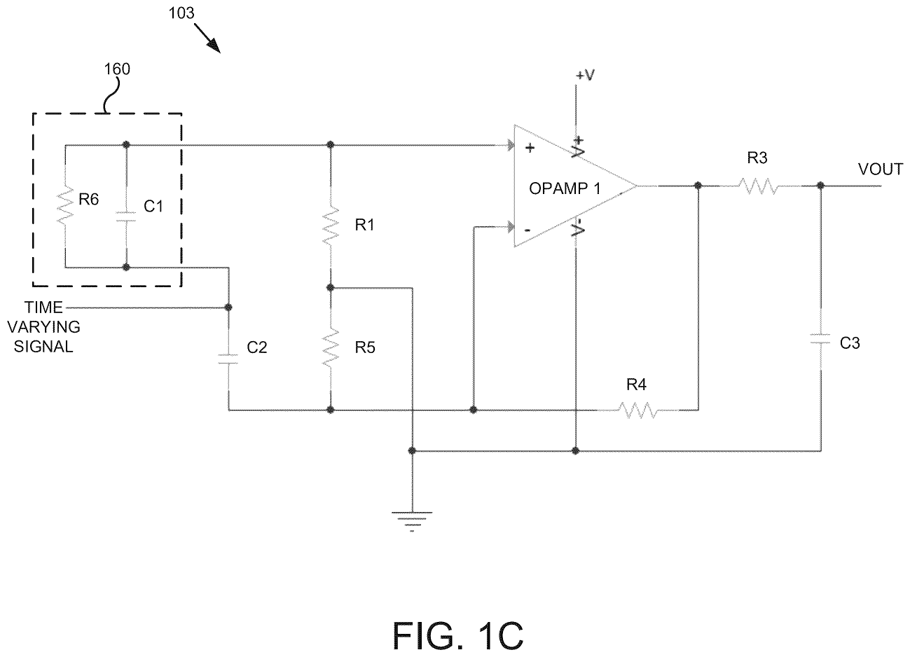

Starting with FIG. 1A, FIG. 1A shows a moisture detection assembly 100 according to one exemplary embodiment of the present disclosure. The moisture detection assembly 100 may include moisture detection circuit 103 (discussed in more detail below in reference to FIG. 1C) and at least two probes 105A and 105B. Each of the at least two probes 105A and 105B may be moisture detection probes. Any number of the probes 105A and 105B may be provided as long as there are at least two of the probes 105A and 105B.

The moisture detection assembly 100 may be disposed (e.g., installed, positioned, placed, positioned, or the like) on a printed circuit board (PCB) 101 and may be coupled (e.g., wired or wirelessly coupled to) a controller 107. The controller 107 may be any type of processor and/or processing unit that is capable of generating, transmitting, receiving, and/or processing electronic signals (e.g., direct current (DC) voltage, alternating current (AC) voltage, clock signals, or the like) such as, but not limited to: an electronic control unit (ECU), a microcontroller, a central processing unit (CPU), a system-on-a-chip (SoC), a microcomputer, or the like. The controller 107 may be configured (as discussed in more detail below in reference to FIG. 1C) to obtain moisture readings from the moisture detection circuit 103.

In embodiments, each of the at least two probes 105A and 105B may be a copper trace that is disposed (e.g., etched, or the like) onto a surface (e.g., a top-most or bottom-most external surface) of the PCB 101. Each copper trace may be of any length, width, and thickness that is required to produce a required resistance value and/or capacitance value between at least two of the copper traces. In the form of copper traces, the at least two probes 105A and 105B may be placed (e.g., may extend) parallel to one another across any part of the surface of the PCB 101 and/or across any distance across the surface of the PCB 101.

Alternatively, each of the at least two probes 105A and 105B may be a terminal pad. More specifically a copper terminal pad.

One having ordinary skill would appreciate that position and placement of the at least two probes 105A and 105B (whether being used in the trace or terminal pad form) on the printed circuit board 101 may be adjusted and/or determined based on a preference of a manufacturer and/or owner of the moisture detection assembly 100 based on configuration that the manufacturer and/or owner believes would allow the at least two probes 105A and 105B to best and most accurately detect any water ingress on and/or around the printed circuit board 101. An example placement of the moisture detection assembly 100 is shown and described below in reference to FIG. 1B.

In embodiments, the controller 107 may be part of the moisture detection assembly 100 (i.e., the controller 107 may be a moisture detection processor and/or controller that is specifically configured for the moisture detection assembly 100). Alternatively, the controller 107 may be an existing controller 107 of another assembly (e.g., a CPU of a motherboard on which the moisture detection assembly is installed as an add-on part and/or assembly).

Similarly, the printed circuit board 101 may be a printed circuit board 101 designed specifically for the moisture detection assembly 100 (i.e., a moisture detection chip, moisture detection PCB, or the like). Alternatively, the printed circuit board 101 may be a printed circuit board of an existing assembly (e.g., a motherboard PCB or the like) to which the moisture detection assembly is installed as an add-on part and/or assembly.

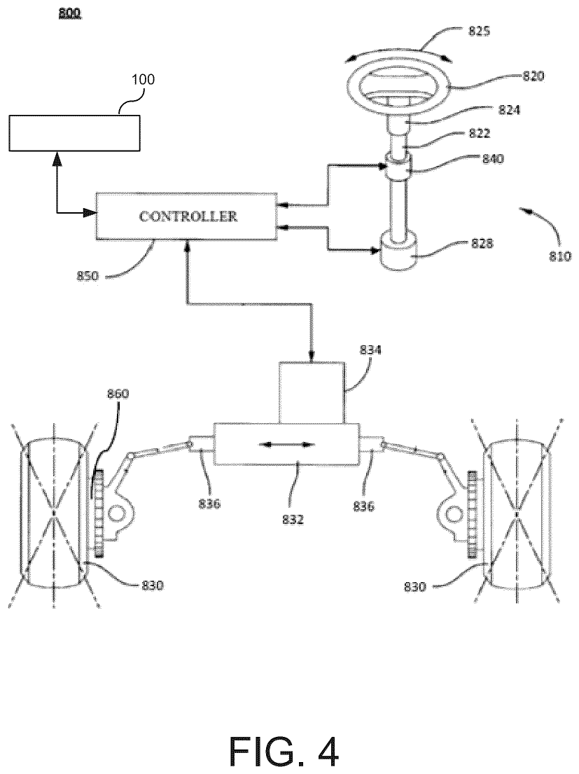

For example, a motor vehicle (and/or any other type of system, device, and/or environment) may already contain one or more electronic circuitry housings that house a central chassis controller (e.g., a main computing system) of the motor vehicle (see, e.g., motor vehicle 800 of FIG. 4) and/or ECU(s) for one or more electro-mechanical brake systems of. The moisture detection assembly 100 may be installed on any existing PCBs (e.g., of the central chassis controller and/or of the ECUs) that are already contained (e.g., enclosed) within these electronic circuitry housings of the motor vehicle.

Although a motor vehicle is used as a specific example above, a person having ordinary skill in the art would appreciate that any other types of systems, devices, and/or environments that could contain one or more electronic circuits and/or circuitry housings may also be applicable (and be substituted for the motor vehicle) without departing from the scope of embodiments disclosed herein.

Turning to FIG. 1B, FIG. 1B shows the printed circuit board 101 having the moisture detection assembly 100 enclosed within an electronic circuitry housing 110 (namely, a housing adapted to hold electronics and electronic circuitry). The electronic circuitry housing 110 may be, for example, a watertight enclosure having a waterproof seal 113 or the like.

In embodiments, the electronic circuitry housing 110 may be mounted at an angle (e.g., tilted at an angle in a tilted manner) within the system, device, and/or environment in which the moisture detection assembly 100 is provided to detect water ingress. Such mounting of the electronic circuitry housing 110 at the angle advantageously allows any water, moisture, and/or humidity that has breached into the electronic circuitry housing 110 to collect (e.g., pool) at the bottom-most corner 118 of the electronic circuitry housing 110. As a result, the at least two probes 105A and 105B of the moisture detection assembly 100 may be positioned and placed to overlap with an area covering this bottom-most corner 118 of the electronic circuitry housing 110 to optimize the detection of water ingress into the electronic circuitry housing 110.

As already discussed above, the placement and position of the at least two probes 105A and 105B of the moisture detection assembly 100 can be optimized (e.g., adjusted) based on the placement and position of the electronic circuitry housing 110. For example, as shown in FIG. 1B where the at least two probes 105A and 105B are shown in the form of copper traces, the copper traces can be routed (e.g., parallel to one another) across any part of the printed circuit board 101 (e.g., that is not already occupied by other electronic components or the like) to detect water ingress (e.g., in the form of a water droplet or the like) at other areas 119 within the electronic circuitry housing 110.

Turning now to FIG. 1C, FIG. 1C shows a first example of the moisture detection circuit 103 in accordance with one or more embodiments disclosed herein. As shown in FIG. 1C, the moisture detection circuit 103 may have one or more electrical components (e.g., resistors, capacitors, operational amplifiers, diodes, or the like).

More specifically, the moisture detection assembly 100 may have a sensing portion 160 made up by the at least two probes 105A and 105B shown in FIG. 1A. In particular, the side-by-side placement of the at least two probes 105A and 105B may mimic the effects of a parallel plate capacitor where a resistive value (R6) and a capacitive value (C1) may be generated between the least two probes 105A and 105B. In other words, R6 and C1 shown in FIG. 1C are not actual physical resistors and capacitors but instead the resistive and capacitive values measured across the at least two probes 105A and 105B.

In embodiments, the at least two probes 105A and 105B be configured (e.g., designed) such that the resistive value between the at least two probes 105A and 105B measures 100 MΩ and the capacitive value between the at least two probes 105A and 105B measures 10 pF when an interior of electronic circuitry housing 110 is completely dry (i.e., when there is no water ingress within electronic circuitry housing 110). When water ingress is present within electronic circuitry housing 110, the capacitive value of C1 and resistive value of R1 may change.

To detect such changes in the capacitive and resistive values of C1 and R1, respectively, a time varying signal (e.g., a clock signal, an AC frequency signal, or the like) may be provided as an input signal into moisture detection circuit 103. The time varying signal may be generated by and provided to the moisture detection circuit 103 by controller 107. In one example, the time varying signal may be set to have the properties (e.g., characteristics) of, but is not limited to: V1=1V, V2=4V, TD=0, TR=2 μ, TF=2 μ, PW=8 μ, PER=20 μ.

Additionally, a physical capacitor C2 that is set to be approximately equal in value to the dry capacitive value (e.g., 10 pF) of C1 may also be provided between the time varying signal and the sensing portion 160. The time varying signal that is applied to the sensing portion 160 and C1 may be processed (e.g., filtered, amplified, converted from AC to DC, or the like) by an operational amplifier OPAMP 1. The gain of OPAMP 1 may be set, for example, using resisters R1, R5, R3, and R4. In one example (e.g., when R6 is set to 100 MΩ and C1 is set to 10 pF to represent the dry condition detected by moisture detection circuit 103), R1, R5, R3, and R4 may be set, respectively, to 10 kΩ, 10 kΩ, 200 Ω, and 750 kΩ.

In embodiments, the operational amplifier OPAMP 1 may be any type of general use operational amplifier that can be used to convert the time varying signal that is in AC form into an analog signal in DC form. For example, an LM324 operational amplifier (or any of its equivalent) may be used in the moisture detection circuit 103.

As the time varying signal that is applied to the sensing portion 160 and C1 is processed by OPAMP 1, OPAMP 1 generates an output (i.e., an analog output) VOUT that indicates whether moisture is detected. This analog output VOUT may be received and processed by controller 107 for the controller 107 to determine whether the moisture detection circuit 103 has detected water ingress (e.g., has detected that the electronic circuitry housing 110 has been compromised through at least water, humidity, and/or moisture leaking into the electronic circuitry housing 110). In particular, this analog output VOUT (of the moisture detection circuit 103) may be used by the controller 107 to determine the change in the capacitive value of C1 and resistive value of R1 (i.e., a change in a capacitance and a change in a resistance between the at least two probes 105A and 105B) when water ingress is detected by the moisture detection circuit 103.

As a non-limiting example, assume that the above-provided properties (e.g., characteristics) of the time varying signal is provided as an input signal into the moisture detection circuit 103. Under dry behavior (i.e., no water ingress conditions), the following values may be determined (e.g., detected) by controller 107 from the analog output VOUT of the moisture detection circuit 103: C1=10 pF; R6=100 MΩ; Output at 0.4V; and a clock of 50% at a duty cycle of 25 kHz.

Now assume that water ingress (e.g., a humid behavior) is detected by the moisture detection circuit 103. Under the same properties/characteristics of the moisture detection circuit 103, the following values may be determined (e.g., detected) by controller 107 from the analog output VOUT under this humid behavior: C1=700 pF; R6=100 kΩ; Output at 5V; and a clock of 50% at a duty cycle of 25 kHz.

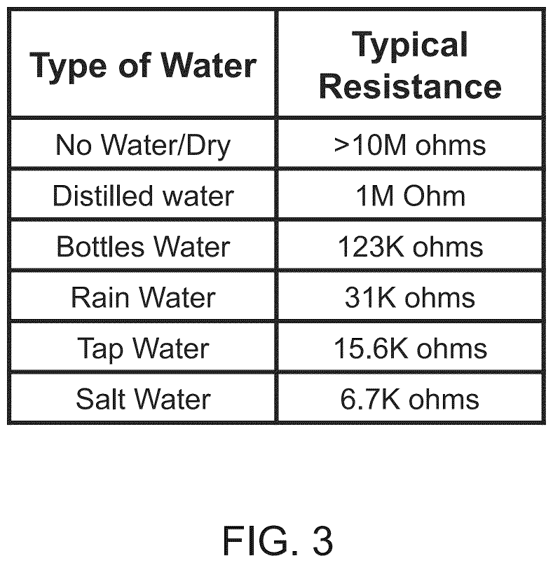

As shown in the above dry and humid behavior conditions, the resistance (i.e., resistive value R1) between the at least two probes 105A and 105B decreases as water, humidity, and/or moisture is present across the at least two probes 105A and 105B. The amount of resistance change may depend on the spacing between the at least two probes 105A and 105B, and may depend on the purity and concentration level of contaminants within the water that is detected (e.g., see the table of FIG. 3 for more details). Thus, this change in resistance (i.e., change in the resistive value of R1) may not only show detection of water ingress but also advantageously identify the type of the water (e.g., distilled, bottled, rain, tap, salt, or the like) that is detected.

In particular, as shown in FIG. 3, different types of water (e.g., that contain different purity and concentration of contaminants) may produce drastically different resistive values for R6. More specifically, each type of water may result in large enough magnitudes of changes in the resistive value of R6 (i.e., the resistance between the at least two probes 105A and 105B) that the controller 107 is able to differentiate the type of water detected during a water ingress event of the electronic circuitry housing 110. This advantageously allows the manufacturer and/or owner of the system, device, and/or environment in which the moisture detection assembly 100 is installed to narrow down not only which type of water is associated with the water ingress event but potentially when and where the water ingress event occurred (e.g., if salt water were detected then the motor vehicle in which the moisture detection assembly 100 is installed must have traveled somewhere where salt water is present such as by a beach or the like).

Additionally, knowing the type of water that caused the water ingress event also advantageously allows the manufacturer and/or owner to determine the extent to which the electronics within the electronic circuitry housing 110 need to be replaced (e.g., cleaner water such as distilled water may less likely cause rust on copper traces and require less replacement and/or maintenance of the electronics, or the like) and/or how likely and/or quickly failure of the electronics may occur (e.g., with cleaner water potentially causing a slower failure rate, or the like).

Returning back to FIG. 1C, the above dry and humid behavior conditions further show that the capacitance (i.e., the capacitive value R6) between the at least two probes 105A and 105B increases (e.g., from 10 pF to 700 pF) as water, humidity, and/or moisture is present across the at least two probes 105A and 105B. Such increase in the capacitance between the at least two probes 105A and 105B is also at such a large magnitude (e.g., up to 88 times the original capacitive value) that the increase can be easily detected by controller 107.

To further increase the sensitivity of the moisture detection circuit 103, the above-discussed time varying signal, the operational amplifier OPAMP 1, and the resistive value (i.e., R6) measurement are provided. For example, assume now a second humid behavior where only a small amount of humidity has penetrated (e.g., as the water ingress) into electronic circuitry housing 110. Such small amount of humidity may only cause a small change to the capacitance (i.e., the capacitive value R6) between the at least two probes 105A and 105B from 10 pF to 20 pF that the controller 107 may not immediately notice and/or detect (or may not trigger a capacitive change threshold preset within controller 107). However, such small amount of humidity may cause the other values to change significantly, for example: R6=10 MΩ and Output of VOUT at 1.6V while the clock and duty cycle values remain constant. This advantageously allows controller 107 to detect (e.g., using the analog output VOUT of the moisture detection circuit 103) even the smallest change of humidity and moisture within the electronic circuitry housing 110 (when these detected values are compared to the default dry behavior condition values). Thus, the accuracy and reliability of the moisture detection circuit 103 described herein can advantageously be improved.

Using the above motor vehicle example for reference, assume that the moisture detection circuit 103 of embodiments disclosed herein is installed within an electronic circuitry housing 110 housing an ECU of at least one electromechanical brake assembly (e.g., of the front left wheel of the motor vehicle). The ECU (e.g., operating as controller 107) detects the water ingress using the analog output VOUT provided by the moisture detection circuit 103 and reports the water ingress to a chassis controller of the motor vehicle, which may then in turn notify a driver (and/or owner or manufacturer if the vehicle is driverless) of the water ingress such that the driver is able to perform one or more actions sets to alleviate any issues and/or dangers (namely, brake failure) associated with the water ingress into the electronic circuitry housing 110 of the electromechanical brake assembly.

Although specific voltage, resistance, capacitance, clock signal, or the like values are provided above, one having ordinary skill in the art would appreciate that any of the above mentioned values may be adjusted based on one or more preferences and/or requirements of an owner and/or manufacturer of the moisture detection circuit 103 and/or the system, device, and/or environment in which the moisture detection circuit 103 is to be installed. For example, the capacitive value of C1 may be adjusted to 50 pF (or any other number) instead of 10 pF to represent the dry condition (e.g., through adjustment of a gain and frequency of the time varying signal, through changing a design and placement of the at least two probes 105A and 105B, or the like).

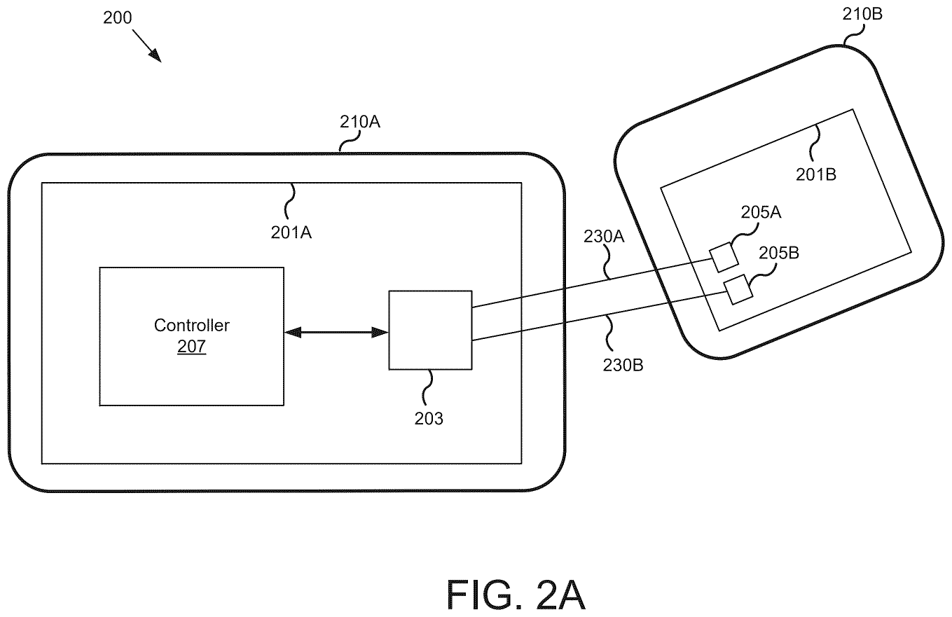

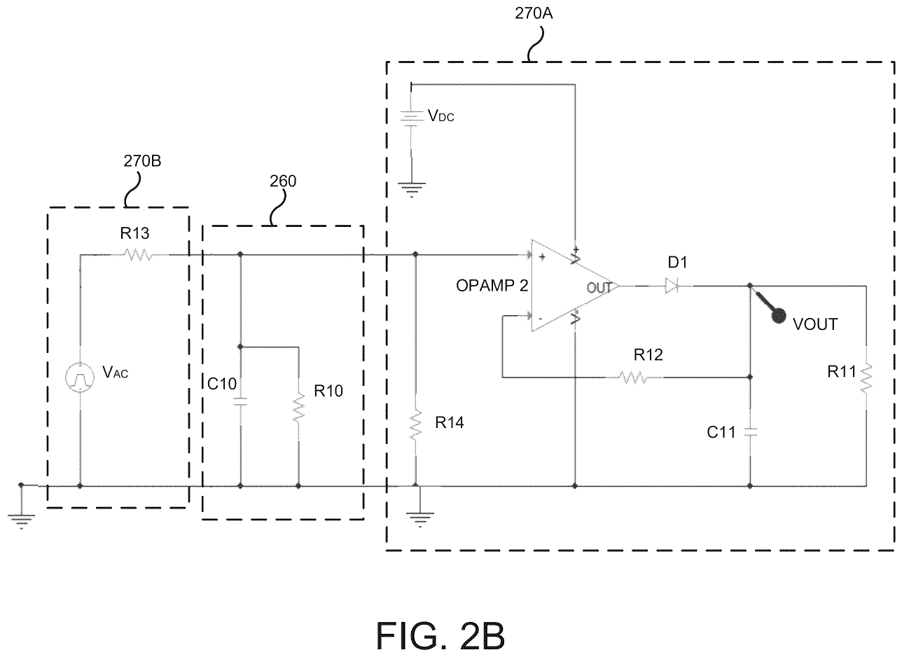

Turning now to FIG. 2A, FIG. 2A another moisture detection assembly 200 according to an exemplary embodiment of the present disclosure.

In embodiments, the moisture detection assembly 200 may have, at least, moisture detection circuit 203 and at least two probes 205A and 205B. The moisture detection circuit 203 and the at least two probes 205A and 205B may be identical to the moisture detection circuit 103 and at least two probes 105A and 105B, respectively, that are discussed in reference to FIGS. 1A-1C.

The moisture detection assembly 200 may also contain controller 207, which may be identical in operation and configuration to controller 107 discussed in reference to FIGS. 1A-1C. Additionally, the moisture detection circuit 203, the at least two probes 205A and 205B, and the controller 207 may be disposed (e.g., installed, positioned, placed, or the like) on printed circuit boards 201A and 201B, each of which may be identical in operation and configuration to printed circuit board 101 discussed in reference to FIGS. 1A-1C.

Further, the printed circuit boards 201A and 201B may be enclosed within electronic circuitry housings 210A and 210B, each of which may be identical in operation and configuration to electronic circuity housing 110 discussed in reference to FIGS. 1A-1C.

As shown in FIG. 2A, a remote sensing configuration of the moisture detection assembly 200 is provided. More specifically, the remote sensing configuration is applicable to systems, devices, and/or environments where one or more remote sensors (e.g., sensors that are remotely and physically spaced apart from a controller (e.g., 107, 207) that obtains readings from the sensors) are installed.

In particular and as shown in FIG. 2A, the electronic circuitry housing 210B houses the remote sensor and/or sensing circuit while the electronic circuitry housing 210A houses the controller 207 that receives sensor readings from the remote sensor(s) enclosed within electronic circuitry housing 210B. As shown in FIG. 2A, the electronic circuitry housing 210B may be mounted (e.g., installed) in a tilted manner. Alternatively, the electronic circuitry housing 210B may be mounted in a non-tiled manner similar to electronic circuitry housing 210A.

Utilizing such existing remote sensing configurations within a system, device, and/or environment, the moisture detection circuit (e.g., 103, 203) of embodiments disclosed herein may be used to ensure that both electronic circuitry housings 210A and 210B are free from water ingress.

In particular, to detect water ingress in the electronic circuitry housing 210B that already houses an existing sensor (e.g., a position sensor, a temperature sensor, or the like or any other types of electronics/electronic components), the at least two probes 205A and 205B may be disposed on printed circuit board 201B enclosed in electronic circuitry housing 210B. In this configuration shown in FIG. 2A, the at least two probes 205A and 205B may make up a second portion of the moisture detection circuit 203.

The first portion of moisture detection circuit 203 may be disposed on printed circuit board 201A that in enclosed in electronic circuitry housing 210A. The first portion of the moisture detection circuit 203 and the second portion of the portion of moisture detection circuit 203 may be connected using communication paths 230A and 230B (e.g., physical and/or non-physical signal communication paths such as remote signals, signal communication wires, communication buses, or the like). These communication paths 230A and 230B may be existing communication paths that already connect any existing sensors on printed circuit board 201B to the controller 207. Thus, addition of new input and/or output signal lines to existing assemblies (e.g., within electronic circuitry housings 210A and 210B) can advantageously be avoided.

Although not shown in FIG. 2A, the first portion of moisture detection circuit 203 may contain yet another set of probes (e.g., a pair of 105A and 105B probe pairs, or the like) for detecting water ingress within electronic circuitry housing 210A. Furthermore, although shown as terminal pads in FIG. 2A, the at least two probes 205A and 205B may alternatively be configured as traces (e.g., copper traces) without departing from the scope of embodiments disclosed herein,

Turning now to FIG. 2B, the first portion of the moisture detection circuit 203 may contain the electronic components and signals shown in portion 270A as well as the electronic components and signals shown in portion 270B of the moisture detection circuit 203. The second portion of the moisture detection circuit 203 may contain sensing portion 260 that is identical in nature to sensing portion 160 discussed in reference to FIG. 1B. Said another way, C10 and R10 shown in sensing portion 260 are again not used to represent actual physical resistors and capacitors but instead used to represent the resistive value and capacitive value measured between the at least two probes 205A and 205B. Similar to C1 and R6, respectively, C10 may be set (in one example of embodiments disclosed herein) to 10 pF while R10 may be set to 100 MΩ.

Portion 270B of the moisture detection circuit 203 shows a time varying signal V_{AC} (e.g., a communication line signal) provided by the controller 207 to the two probes 205A and 205B via communication paths 230A and 230B. In one example, the time varying signal V_{AC} may be set to have the properties (e.g., characteristics) of, but is not limited to: V1=0.5V, V2=4V, TD=0, TR=2 μ, TF=2 μ, PW=20 μ, PER=300 μ.

In embodiments, resistor R13 shown to be part of portion 270B may be a physical resistor disposed either on printed circuit board 201A as part of portion 270A or on printed circuit board 201B as part of sensing portion 260 with the at least two probes 205A and 205B.

Portion 270A of the first portion of the moisture detection circuit 203 may contain operational amplifier OPAMP 2 that, similar to OPAMP 1, processes the time varying signal V_{AC} applied through the at least two probes 250A and 250B. In the example configuration shown in FIG. 2B, the circuit for OPAMP 2 may contain, but should not be limited to: diode D1, resistor R11, resistor R12, resistor R14, and capacitor C11. The values of R11, R12, R14, and C11 may be, respectively, but limited to: 200 kΩ, 1 kΩ, 10 MΩ, and 0.47 μF. Diode D1 may be any type of diode (e.g., any general-purpose small signal type diode) while OPAMP 2, similar to OPAMP 1, may be any type of general and/or specialized operational amplifier. V_{DC} may be set to any voltage required for operation of OPAMP 2. Operational amplifier OPAMP 2 may produce an analog signal VOUT (similar to analog signal VOUT discussed in reference to FIG. 1C) that is obtained (e.g., provided) to controller 207 for the controller 207 to detect any water ingress events using moisture detection circuit 203.

In one example, the dry behavior for the moisture detection circuit 203 may be set as: C10=10 pF; R10=100 MΩ; Output at 3.9V; and a clock of 18% at a duty cycle of 3.3 kHz. A first humid behavior for the moisture detection circuit 203 may be detected (e.g., by controller 207) as: C10=30 pF; R10=10 MΩ; Output at 3.85V; and a clock of 18% at a duty cycle of 3.3 kHz. A second behavior for the moisture detection circuit 203 may be detected (e.g., by controller 207) as: C10=700 pF; R10=100 kΩ; Output at 1.5V; and a clock of 18% at a duty cycle of 3.3 kHz.

As shown in these example behaviors, the voltage value of the analog signal VOUT of moisture detection circuit 203 decreases as more humidity, moisture, and/or water is detected, which is the opposite to the behavior of analog signal VOUT of moisture detection circuit 103 where the voltage value increases as more humidity, moisture, and/or water is detected.

Similar to moisture detection circuit 103, moisture detection circuit 203 can also be used (e.g., by controller 207 via obtaining of analog signal VOUT from moisture detection circuit 203) to determine (e.g., using the resistance measured) to determine a type of water associated with a detected water ingress event.

Any motor vehicles discussed in reference to FIGS. 1A-2B may be identical, or substantially similar to, vehicle 800 shown in FIG. 4. The vehicle 800 may be any passenger or commercial automobile such as a hybrid vehicle, an electric vehicle, or any other type vehicles. FIG. 4 is a schematic view of a vehicle 800 including a steering system and a brake assembly according to an exemplary embodiment of the present disclosure. The vehicle 800 may include a steering system 810 for use in a vehicle. The steering system 810 can allow a driver or operator of the vehicle 800 to control the direction of the vehicle 800 or road wheels 830 of the vehicle 800 through the manipulation of a steering wheel 820. The steering wheel 820 is operatively coupled to a steering shaft (or steering column) 822. The steering wheel 820 may be directly or indirectly connected with the steering shaft 822. For example, the steering wheel 820 may be connected to the steering shaft 822 through a gear, a shaft, a belt and/or any connection means. The steering shaft 822 may be installed in a housing 824 such that the steering shaft 822 is rotatable within the housing 824.

The road wheels 830 may be connected to knuckles, which are in turn connected to tie rods. The tie rods are connected to a steering assembly 832. The steering assembly 832 may include a steering actuator motor 834 and steering rods 836. The steering rods 836 may be operatively coupled to the steering actuator motor 834 such that the steering actuator motor 834 is adapted to move the steering rods 836. The movement of the steering rods 836 controls the direction of the road wheels 830 through the knuckles and tie rods.

One or more sensors 840 may be configured to detect position, angular displacement or travel 825 of the steering shaft 822 or steering wheel 820, as well as detecting the torque of the angular displacement. The sensors 840 provide electric signals to a controller 850 indicative of the angular displacement and torque 825. The controller 850 sends and/or receives signals to/from the steering actuator motor 834 to actuate the steering actuator motor 834 in response to the angular displacement 825 of the steering wheel 820. Controller 850 may be a chassis controller of the vehicle 800 and may also be connected (e.g., physically or non-physically) to one or more moisture detection assemblies 100 (or moisture detection assemblies 200).

In the steer-by-wire steering system, the steering wheel 820 may be mechanically isolated from the road wheels 830. For example, the steer-by-wire system has no mechanical link connecting the steering wheel 820 from the road wheels 830. Accordingly, the steer-by wire steering system may comprise a feedback actuator or steering feel actuator 828 comprising an electric motor which is connected to the steering shaft or steering shaft 822. The feedback actuator or steering feel actuator 828 provides the driver or operator with the same “road feel” that the driver receives with a direct mechanical link.

Although the embodiment illustrated in FIG. 4 shows the vehicle 800 having the steer-by-wire steering system, the vehicle 800 may alternatively have a mechanical steering system without departing from embodiments disclosed herein. The mechanical steering system typically includes a mechanical linkage or a mechanical connection between the steering wheel 820 and the road wheels 830. In the mechanical steering system, the steering actuator motor 834 includes an electric motor to provide power to assist the movement of the road wheels 830 in response to the operation of the driver or a control signal of the controller 850. Accordingly, the electric motor can be used as the steering actuator motor 834 or can be included in the feedback actuator or steering feel actuator 828.

The electric motor can also be employed in an electromagnetic brake assembly 860. The electromagnetic brake assembly 860 is configured to cause the road wheel 830 to slow or stop motion using electromagnetic force to apply mechanical resistance or friction by using the torque generated by the electric motor.

Although the example embodiments have been described in detail, it should be understood that various changes, substitutions and alterations can be made herein without departing from the spirit and scope of the application as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

What is claimed is:

1. A moisture detection assembly comprising:
a moisture detection circuit disposed on a printed circuit board, the moisture detection circuit comprising at least two probes that are disposed side-by-side to one another on the printed circuit board,
wherein the moisture detection circuit is coupled to a controller configured to obtain moisture readings from the moisture detection circuit by determining a change in capacitance and a change in resistance between the at least two probes.

2. The moisture detection assembly of claim 1, wherein the controller is configured to detect moisture based on the change in the capacitance between the at least two probes and to identify a type of water associated with the moisture that is detected based on the change in the resistance between the at least two probes.

3. The moisture detection assembly of claim 2, wherein the type of the water that is detected comprises distilled water, bottled water, rainwater, tap water, and salt water.

4. The moisture detection assembly of claim 3, wherein the moisture detection circuit comprises at least one capacitor, and a value of the at least one capacitor being equal to a capacitance value between the at least two probes that is associated with a no moisture detected condition.

5. The moisture detection assembly of claim 4, wherein the controller is configured to provide a time varying signal as an input signal into the moisture detection circuit and receives an output signal based on the time varying signal from the moisture detection circuit, the time varying signal being changed based on the change in the capacitance and the change in the resistance between the at least two probes.

6. The moisture detection assembly of claim 5, wherein the controller is configured to obtain a contaminant concentration level of the type of the water that is detected based on the change in the resistance between the at least two probes, and a magnitude of the change in the resistance.

7. The moisture detection assembly of claim 2, wherein the at least two probes comprise a first terminal pad as a first probe of the at least two probes and a second terminal pad as a second probe of the at least two probes, and the first terminal pad and the second terminal pad both comprise copper pads and are disposed on an external surface of the printed circuit board.

8. The moisture detection assembly of claim 2, wherein the at least two probes comprise a first copper trace as a first probe of the at least two probes and a second copper trace as a second probe of the at least two probes, and the first copper trace and the second copper trace are disposed parallel to one another on an external surface of the printed circuit board.

9. The moisture detection assembly of claim 2, wherein the printed circuit board is enclosed in a watertight enclosure, and the moisture detection assembly is configured to detect water leakage into the watertight enclosure.

10. The moisture detection assembly of claim 9, wherein the watertight enclosure is disposed in a tilted manner within a system in which the moisture detection assembly is installed.

11. A moisture detection assembly comprising:
a moisture detection circuit comprising:
a first portion that is disposed on a first printed circuit board, and the first printed circuit board comprising a controller; and
a second portion that is disposed on a second printed circuit board that is remote to the first printed circuit board, the second portion comprising at least two probes that are disposed side-by-side to one another on the second printed circuit board and that are remotely connected to the first portion of the moisture detection circuit,
wherein the controller on the first printed circuit board is configured to obtain moisture readings from the at least two probes on the second printed circuit board by determining a change in capacitance and a change in resistance between the at least two probes that are on the second printed circuit board.

12. The moisture detection assembly of claim 11, wherein the at least two probes of the second portion of the moisture detection circuit are connected to the first portion of the moisture detection circuit via signal communication paths.

13. The moisture detection assembly of claim 12, wherein the controller is configured to detect moisture based on the change in the capacitance between the at least two probes and to detect a type of water associated with the moisture that is detected based on the change in the resistance between the at least two probes.

14. The moisture detection assembly of claim 13, wherein the type of the water that is detected comprises distilled water, bottled water, rainwater, tap water, and salt water.

15. The moisture detection assembly of claim 14, wherein the controller is configured to obtain a contaminant concentration level of the type of the water that is detected based on the change in the resistance between the at least two probes, and a magnitude of the change in the resistance is dependent on an amount of space that exists between the at least two probes.

16. The moisture detection assembly of claim 12, wherein the controller is configured to provide a time varying signal as an input signal into the moisture detection circuit and receives an output signal based on the time varying signal from the moisture detection circuit, the time varying signal being changed based on the change in the capacitance and the change in the resistance between the at least two probes.

17. The moisture detection assembly of claim 16, wherein the controller is configured to provide the time varying signal to the at least two probes via the signal communication paths, the first portion of the moisture detection circuit is configured to receive a return signal from the at least two probes via the signal communication paths, the first portion of the moisture detection circuit is configured to process the return signal to generate the output signal that is provided to the controller.

18. The moisture detection assembly of claim 12, wherein the first printed circuit board is enclosed within a first watertight enclosure and the second printed circuit board is enclosed within a second watertight enclosure that is separate and physically spaced apart from the second watertight enclosure, and the signal communication paths comprise communication wires that run between the first watertight enclosure and the second watertight enclosure.

19. The moisture detection assembly of claim 18, wherein the second watertight enclosure is disposed in a tilted manner within a system is which the moisture detection assembly is installed.

20. The moisture detection assembly of claim 12, wherein the first printed circuit board is enclosed within a first watertight enclosure and the second printed circuit board is enclosed within a second watertight enclosure that is separate and physically spaced apart from the second watertight enclosure, and the signal communication paths are non-physical signals that are transmitted between the first watertight enclosure and the second watertight enclosure.
